(19) United States
(12) Patent Application Publication
(10) Pub. No.: US 2026/0218887 A1
(43) Pub. Date: Jul. 30, 2026

(54) LIGHTING FIXTURE FOR OUTDOOR USE

(71) Applicant: STELLA IMPORTAÇÃO E EXPORTAÇÃO DE LUMINÁRIAS LTDA, Sapiranga (BR)

(72) Inventor: Lisandro Henrique BERLITZ, Sapiranga (BR)

(21) Appl. No.: 19/147,694

(22) PCT Filed: Jan. 13, 2023
(86) PCT No.: PCT/BR2023/050012

§ 371 Date: Jul. 12, 2025

(51) Int. Cl. F21V 21/08; F21V 29/78; F21W 131/109; F21Y 115/10

(52) U.S. Cl. CPC F21V 21/0824; F21V 29/78; F21W 2131/109; F21Y 2115/10

(57) ABSTRACT

The light fixture for outdoor use, which is the object of the present invention, comprises a embedded light fixture for garden spikes, used for application in outdoor areas, equipped with a body (10) that has a driver (20), heatsink (30), LED (41) and lens (50) arranged next to the body (60) equipped with a recess (62) that guarantees perfect sealing, efficiency and durability in its application.

### FIELD OF THE INVENTION

The present invention relates to a light fixture for outdoor use. More specifically, it comprises an embedded light fixture for garden spikes, used for application in outdoor areas, equipped with an embodiment ensuring perfect sealing, efficiency, and durability in its application.

### BACKGROUND OF THE INVENTION

Currently, outdoor light fixtures require watertight seals to ensure the safety of the installation for both residents and the installed products. These light fixtures typically suffer from capillary action when exposed to flooding, causing the cable to conduct water into the product. Furthermore, the embodiment of these light fixtures also creates several points with poor watertightness, particularly in the way the body and lens are attached, which in many cases allows water to enter and cause irreparable damage.

On the other hand, these light fixtures have a rough embodiment, as due to the arrangement of the internal components, it is necessary to apply longitudinal fins to the external surface to improve heat dissipation of the electronic components, resulting in a negative aesthetic effect for external applications where the product is visible.

Thus, the present inventor, seeking to improve the embodiment, has developed an outdoor light fixture that presents a simplified embodiment that guarantees greater tightness and better efficiency in heat dissipation, assuring greater variability in its application.

In research done on prior art, we identified several documents that describe solutions applied to outdoor light fixtures, wherein we can highlight the following documents:

U.S. Pat. No. 9,845,928 (UST. 2016) describes a grade light fixture provided with a corrugated housing design. The corrugated housing design improves structural integrity and airflow within the light fixture for easier cooling. The light fixture includes an annular door with slots aligned with the corrugations to facilitate the inflow of cool air into the housing and the exhaust of hot air from the housing.

U.S. Pat. No. 10,161,621 (ABL. 2016) describes a grade light fixture grade with hermetically sealed components that allow water and air to pass through the light fixture to effect cooling without degrading the light fixture components.

CN209294855 (Dongxu. 2018) describes an LED lighting module and a garden lamp using thereof, the LED lighting module comprises a heat dissipation assembly, the heat dissipation assembly comprises a light source installation platform, a radiator, a heat storage medium and a back cover.

These documents cited in the prior art describe outdoor light fixtures with their own embodiments, so that none of the cited documents present a light fixture with the same embodiment characteristics that make it possible to improve watertightness and heat dissipation, with a simplified embodiment and form.

Thus, the object of the present invention is a light fixture for outdoor use, for embedding or for use in garden spikes, which has an embodiment that guarantees perfect sealing, efficiency, and durability in its application.

### SUMMARY OF THE INVENTION

The present invention features a light fixture for outdoor use providing a body that allows a driver to be fixed and fitted with support next to the internal base.

The present invention features a light fixture for external use providing a body that allows the fixing and fitting of a heat sink that receives the LED fixation with support.

The present invention features a light fixture for outdoor use providing a heat sink equipped with fins that has greater efficiency.

The present invention features a light fixture for external use providing a second body arranged on the heatsink that allows the lens to be fixed.

The present invention features a light fixture for outdoor use providing a second body with a delimiting edge that allows the formation of a recess that minimizes glare.

### BRIEF DESCRIPTION OF THE FIGURES

FIG. 1 shows the perspective view of the light fixture.

FIG. 2 shows the bottom perspective view of the light fixture.

FIG. 3 shows the front view of the light fixture.

FIGS. 4, 4A, 4B show sectional views of the light fixture, detailing its internal components.

FIG. 5 shows the details of the body base, demonstrating the driver support attachment.

FIG. 6 shows the perspective view of the heat sink.

FIG. 7 shows the rear perspective view of the heat sink, detailing the fins and the direction of dissipation.

FIG. 8 shows a perspective view of the details of how the heatsink is attached to the body.

FIG. 9 shows the exploded view of the light fixture, detailing all the components.

FIG. 10 shows the application of the light fixture along with the embedded support in the ground and floor.

FIG. 11 shows the application of the second construction form of the light fixture, which allows its application next to the garden spike.

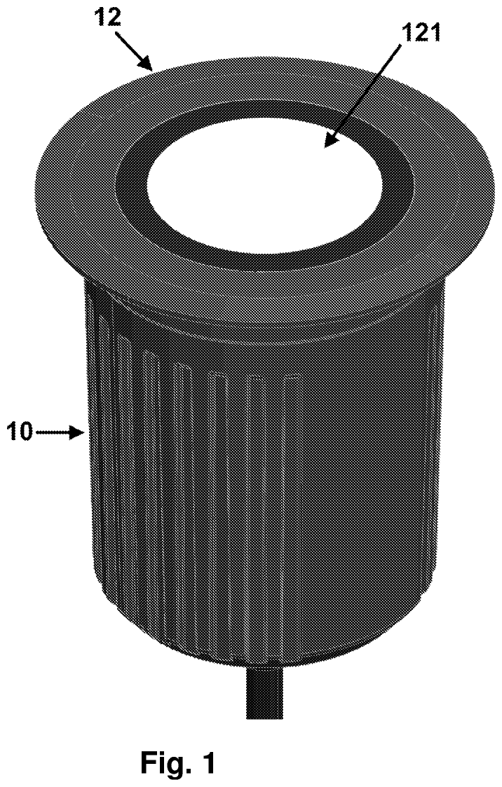

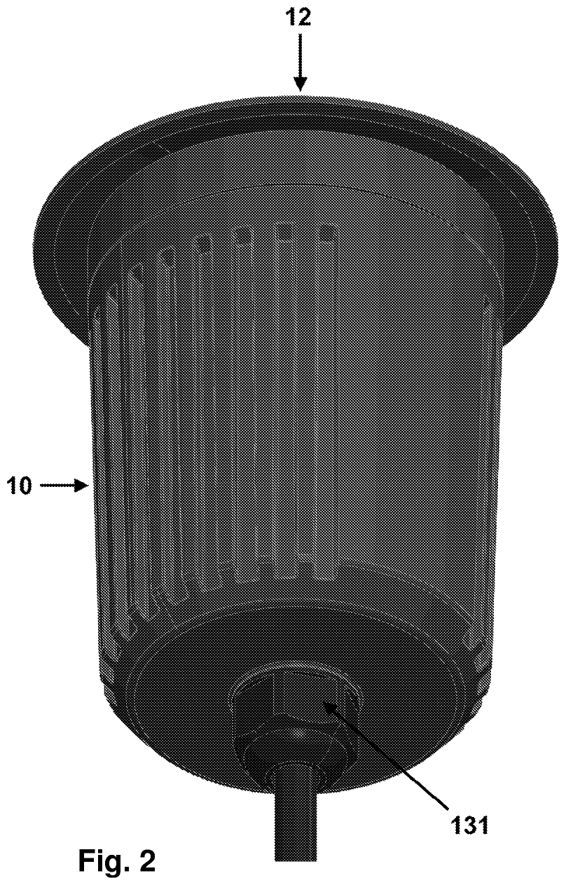

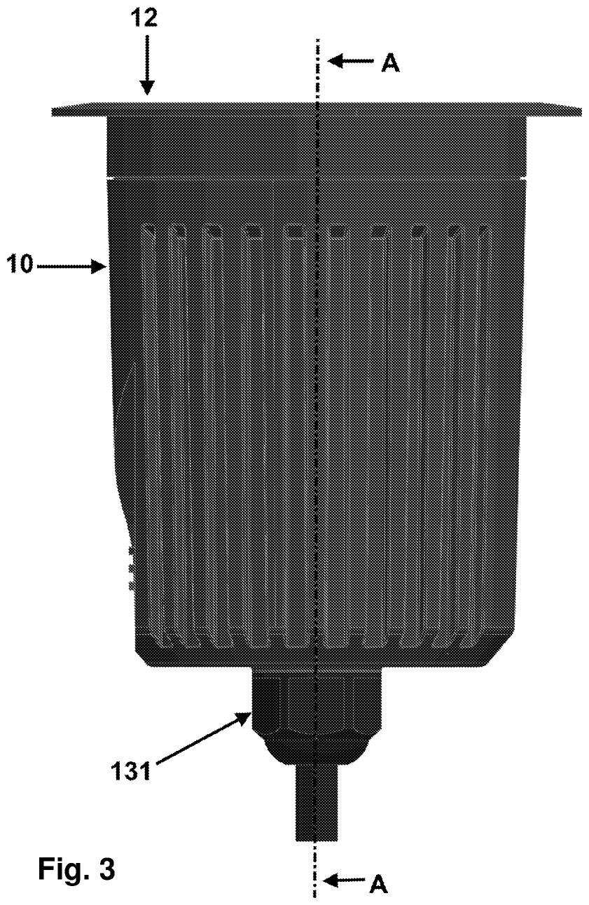

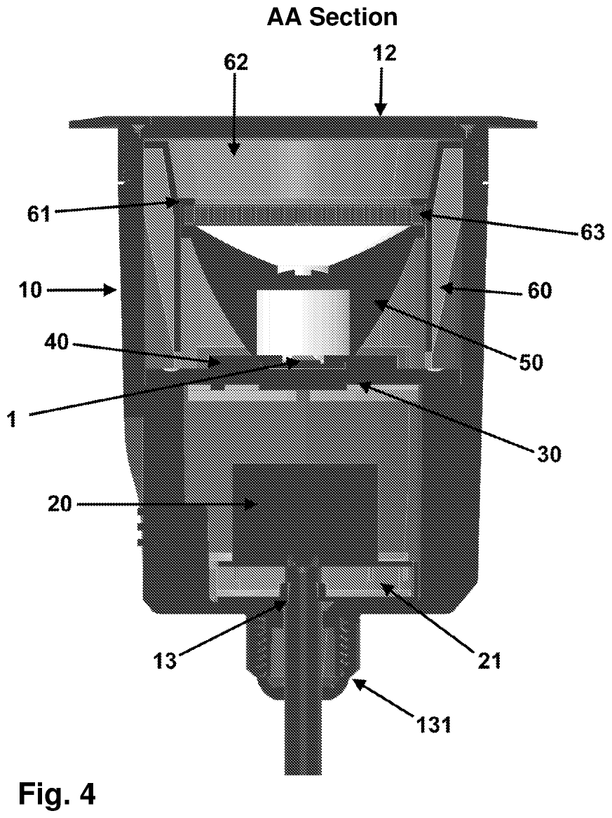

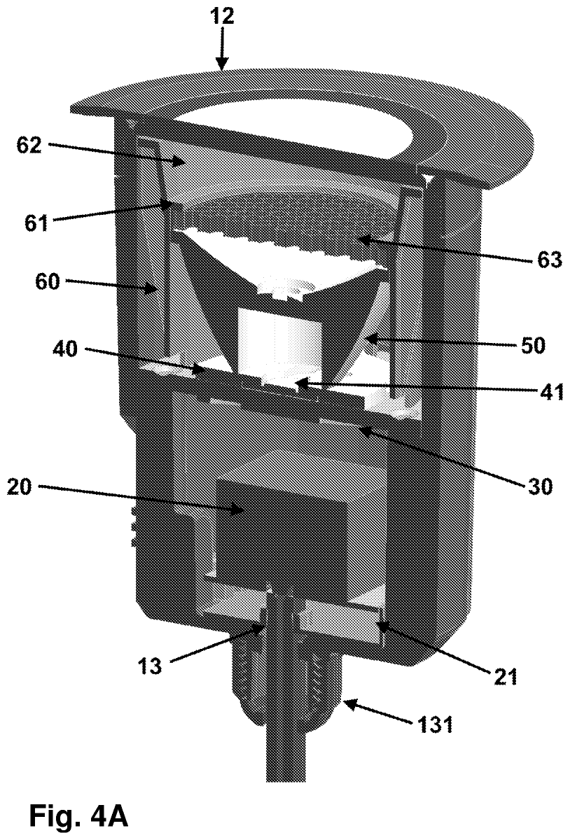

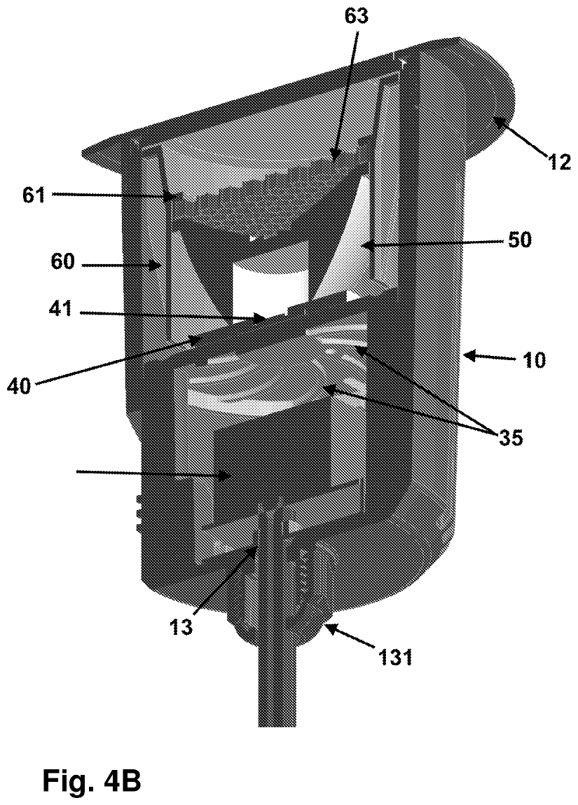

### DETAILED DESCRIPTION OF THE INVENTION

The light fixture for outdoor use, which is the object of the present invention, comprises an external body (10) of cylindrical shape that has an upper edge (11) allowing the positioning of the closing flange (12) through a thread that allows them to be screwed into each other, adding silicone to seal the product in order to prevent water penetration.

In the internal portion, the body (10) presents the driver (20) and support (21) that allows the driver (20) to be fitted and fixed to the internal base of the body (10).

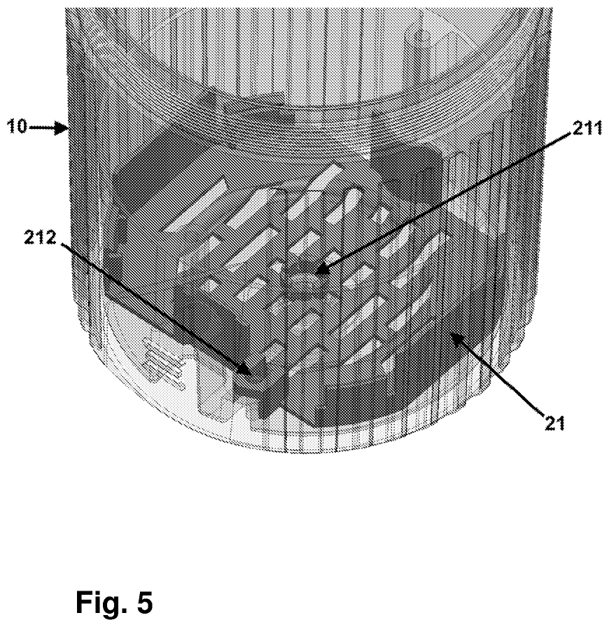

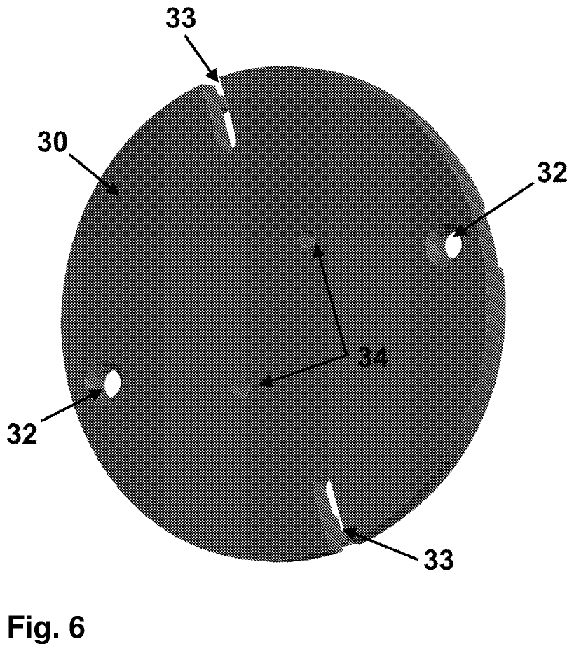

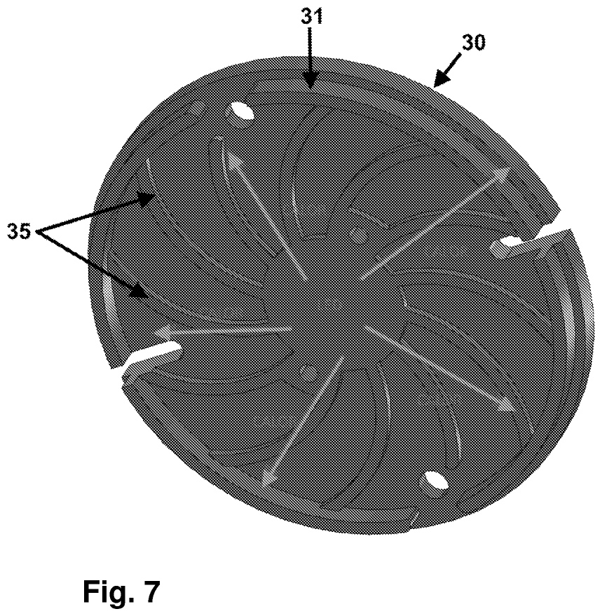

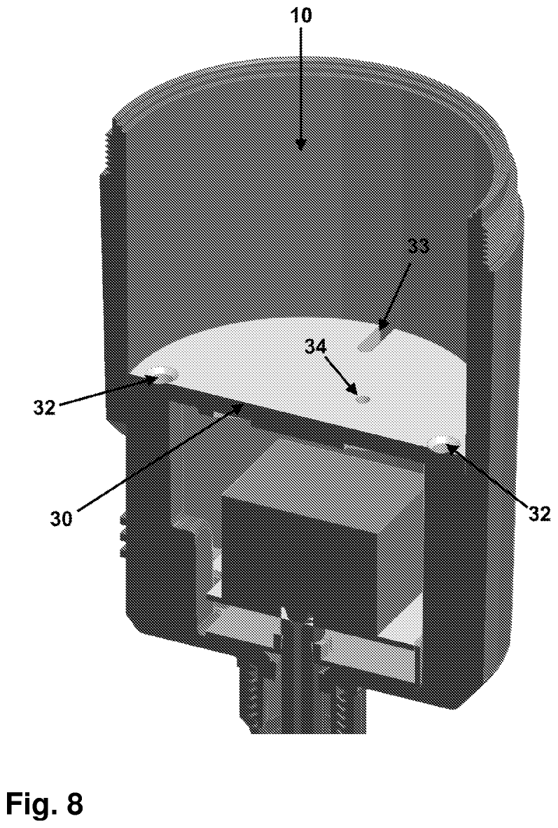

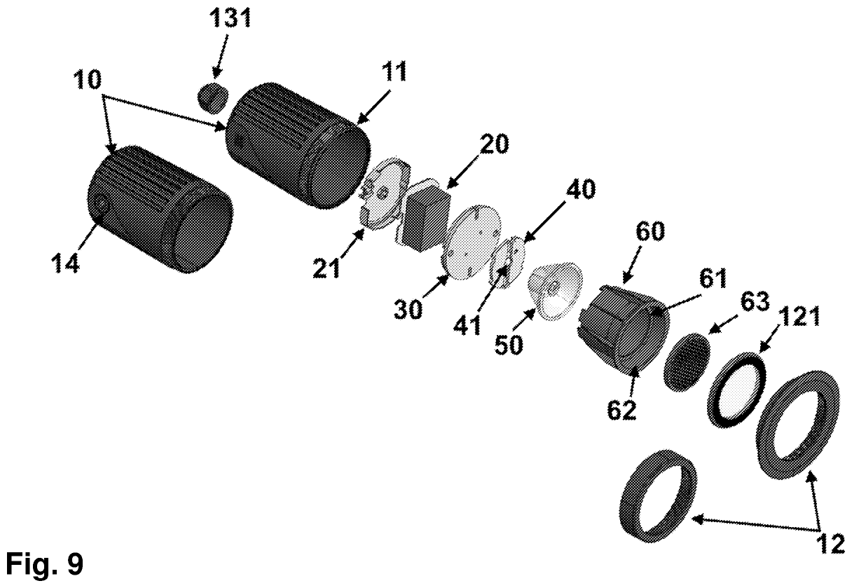

The support (21) is equipped with a central hole (211) and a tab (212) for fixing and fitting to the body (10), with the support resting on the bottom of the body, aligning the hole (211) with the hole (13) in the body and positioning the tab (212) over an internal projection of the body that allows the support (21) and the grounding conductor of the assembly to be screwed in, as shown in FIG. 5.

The driver (20) is positioned on the support (21) so that the external power cable, which enters the body (10) through the hole (13), is connected to the driver in order to transform the e alternating current into direct current, allowing the LED (41) arranged next to the support (40) to be powered.

The body (10) internally has a set of projections that allow the heat sink (30) to be fixed and fitted using screws, positioned on the driver (20) in such a way as to allow the LED (41) support (40) to be fixed.

The heatsink (30) has a raised edge (31) that allows it to be fitted and positioned on the internal projections of the body (10), it has a pair of holes (32) for fixing the heatsink (30) using screws next to the body and a pair of grooves (33) that allow the wiring from the driver (20) to the LED (41) to pass through.

The heatsink (30) is equipped with holes (34) that allow the positioning and fixing of the support (40) of the LED (41), using a screw, in the center of the heatsink.

The heatsink (30) is equipped with fins (35) positioned on the lower face, towards the driver, which allow the heat emanating from the LED (41) to be directed to the ends of the heatsink, thus transferring it to the body (10) of the light fixture and increasing the efficiency of heat exchange.

The support (40) allows the lens (50) to be fixed in order to position the assembly over the LED (41) allowing the light beam to be formed.

The body (60) is positioned on the heatsink (30) and next to the upper portion of the lens (50), said body (60) being equipped with an edge (61) that allows the positioning of the lens (50) and delimiting the formation of a recess (62) that aims to improve the visual comfort of the light fixture in order to minimize glare, preventing the emitted light from reaching the eyes of anyone passing by.

The body (60) allows the positioning of an anti-glare grid (63) positioned over the lens (50) and below the edge (61) of the body (60).

The flange (12) is equipped with a protective glass (121) that guarantees the perfect sealing of the assembly, said glass (121) that is fixed to the flange by applying resin to the edge of the glass and then the flange is threaded onto the body (10) so that the flange (12) presses against the glass, promoting fixation.

The body (10) has an entry point (13) for the power cable on the external face of the base, equipped with a cable gland (131), ensuring perfect sealing to prevent water from entering the light fixture.

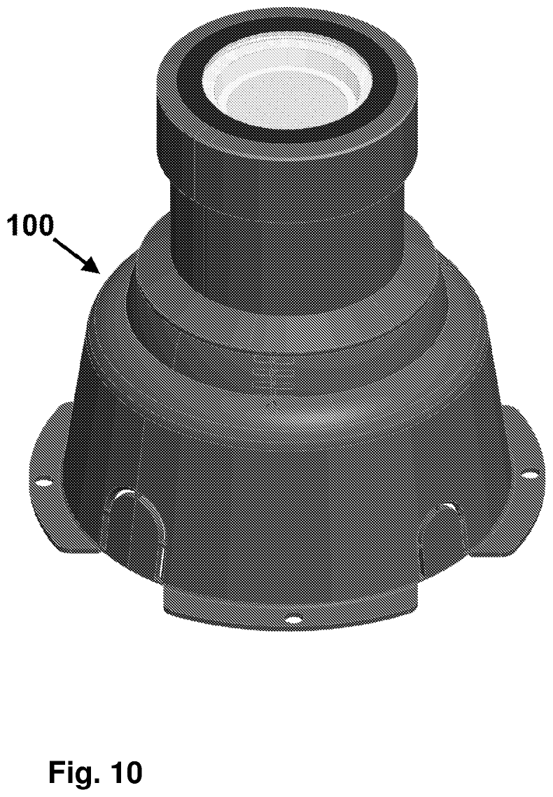

FIG. 10 shows the application of the light fixture along with the support (100) to embed and arrange the light fixture on the ground or floor, detailing its application method.

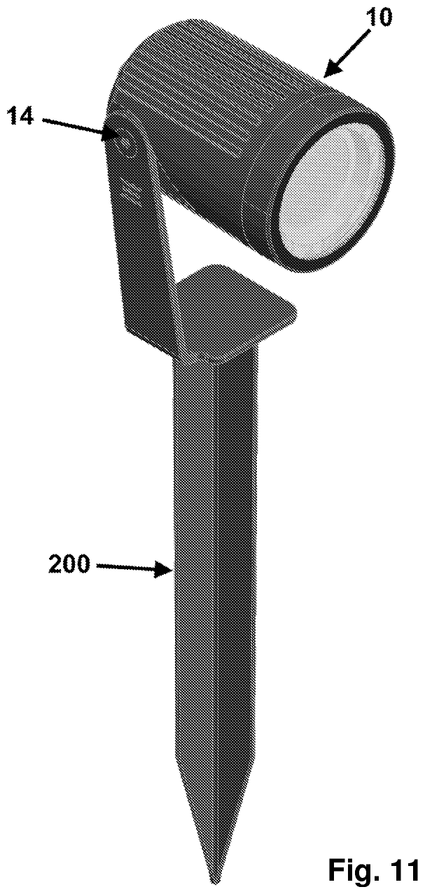

The body (10), in a second embodiment, has lateral fixing points (14) for application and use together with a garden spike (200), as shown in FIG. 11.

1. A LIGHT FIXTURE FOR OUTDOOR USE THAT HAS AN EXTERNAL BODY (10) OF CYLINDRICAL SHAPE WITH CLOSING FLANGE (12), characterized in that the body (10) internally has a driver (20) equipped with a support (21) fixed to the base and a set of projections that allow the fixing and fitting of the heat sink (30) for fixing the support (40) with LED (41) in the central portion, said heat sink (30) that is equipped with fins (35) positioned on the lower face, towards the driver, which allow directing the heat emanating from the LED (41) to the ends of the heat sink next to the body (10); the body (60), arranged on the heat sink (30), has an edge (61) for positioning the lens (50) that results in the formation of a recess (62) to minimize glare.

2. THE LIGHT FIXTURE FOR OUTDOOR USE, according to claim 1, characterized in that the flange (12) is provided with glass (121) to be threaded onto the body (10) and receives silicone for sealing.

3. THE LIGHT FIXTURE FOR OUTDOOR USE, according to claim 1, characterized in that the body (10) has on the external face of the base an entry point (13) for the power cable equipped with a cable gland (131).

4. THE LIGHT FIXTURE FOR OUTDOOR USE, according to claim 1, characterized in that the support (21) is equipped with a central hole (211) and a tab (212) for fixing and fitting to the body (10), with the support resting on the bottom of the body, aligning the hole (211) with the hole (13) in the body and positioning the tab (212) over an internal projection of the body that allows the support (21) and the grounding conductor of the assembly to be screwed on.

5. THE LIGHT FIXTURE FOR OUTDOOR USE, according to claim 1, characterized in that the heatsink (30) is equipped with a raised edge (31) that allows fitting and positioning on the internal projections of the body (10), has a pair of holes (32) for fixing the heatsink (30) using screws next to the body and a pair of grooves (33) that allow the passage of wiring from the driver (20) to the LED (41).

6. THE LIGHT FIXTURE FOR OUTDOOR USE, according to claim 1, characterized in that the heatsink (30) is equipped with holes (34) that allow the positioning and fixing of the support (40) of the LED (41), using a screw, in the center of the heatsink.

7. THE LIGHT FIXTURE FOR OUTDOOR USE, according to claim 1, characterized in that the support (40) allows the lens (50) to be fixed in order to position the assembly over the LED (41) allowing the light beam to be formed.

8. THE LIGHT FIXTURE FOR OUTDOOR USE, according to claim 1, characterized in that the body (60) allows the positioning of an anti-glare grid (63) positioned over the lens (50) and below the edge (61) of the body (60).

9. THE LIGHT FIXTURE FOR OUTDOOR USE, according to claim 1, characterized in that the body (10) has lateral fixing points (14) for fixing the garden spike (200).
